(19) United States
(12) Patent Application Publication
(10) Pub. No.: US 2025/0044538 A1
(43) Pub. Date: Feb. 6, 2025

(54) OPTICAL CONTAINER OF OPTICAL COMPONENT FORMED FROM POLYMERIC COMPOSITION WITH AVERSIVE ADDITIVE

(71) Applicant: CORNING RESEARCH & DEVELOPMENT CORPORATION, Corning, NY (US)

(72) Inventors: Scott M. Adams, Newton, NC (US); Linda Sue Baker, Addison, NY (US); Nilson Hernandez Gabela, Clover, SC (US); Michael John Gimblet, Conover, NC (US); Natalya Vyacheslavovna Zaytseva, Painted Post, NY (US)

(21) Appl. No.: 18/920,125

(22) Filed: Oct. 18, 2024

Related U.S. Application Data
(63) Continuation of application No. PCT/US2023/022692, filed on May 18, 2023.
(60) Provisional application No. 63/347,165, filed on May 31, 2022.

(51) Int. Cl. G02B 6/44; G02B 6/02

(52) U.S. Cl. CPC G02B 6/4432; G02B 6/02052

(57) ABSTRACT

Embodiments of an optical component are provided. The optical component includes an optical container formed from a polymeric composition and an optical element having at least one optical fiber. The optical element is disposed within the optical container. The polymeric composition includes a polymer component and a first aversive additive dispersed in the polymer component. The first aversive additive includes first inorganic particles having an open structure and a chemical aversive material infused into the first inorganic particles. Also provided are embodiments of an optical container made from a polymer composition containing an aversive additive and a method of forming same.

### CROSS-REFERENCE TO RELATED APPLICATIONS

This application is a continuation of International Application No. PCT/US2023/022692, filed May 18, 2023, which claims the benefit of priority of U.S. Provisional Application Ser. No. 63/347,165 filed on May 31, 2022, the content of which is relied upon and incorporated herein by reference in its entirety.

### BACKGROUND

The disclosure relates generally to optical components and more particularly to optical components having optical containers including aversive materials. Cables, such as power transmission cables, telephone cables, optical fiber cables, etc., are used to transmit electricity and/or data over distance. In order to do so, the cables have to be strung across land and/or buried in the ground between electricity/data sources and delivery points. Additionally, such cables are terminated or joined at various enclosures throughout the network. Rodents have been known to chew on cables and enclosures, which damages the cables and enclosures and which can cause network failure. Rodents chew on cables and enclosures for a variety of reasons, such as chewing by juvenile rodents to explore their surroundings, leaving or replacing a scent to mark a rodent's territory, and creating of a nesting site around or within the cables and enclosures. According to some estimates, squirrels alone are attributed with causing approximately 17% of damage to aerial cables.

### SUMMARY

In one aspect, embodiments of the present disclosure relate to an optical component. The optical component includes an optical container formed from a polymeric composition and an optical element having at least one optical fiber. The optical element is disposed within the optical container. The polymeric composition includes a polymer component and a first aversive additive dispersed in the polymer component. The first aversive additive includes first inorganic particles having an open structure and a chemical aversive material infused into the first inorganic particles.

In another aspect, embodiments of the present disclosure relate to a method of forming an optical component. In the method, a chemical aversive material is infused into first inorganic particles having an open structure to form a first aversive additive. The first aversive additive is compounded with a polymer component to form a polymeric composition. The polymer composition is formed into an optical container of the optical component. The optical container is configured to surround at least one optical element of the optical component.

In still another aspect, embodiments of the present disclosure relate to an optical container configured to at least partially surround an optical element having at least one optical fiber. The optical container is formed from a polymeric composition including polymer component and a first aversive additive dispersed in the polymer component. The first aversive additive includes first inorganic particles having an open structure and a chemical aversive material infused into the first inorganic particles.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments.

FIG. 1 depicts an optical fiber cable having a cable jacket containing mechanical and chemical aversive additives, according to an exemplary embodiment;

FIG. 2 is a flow diagram of the steps of preparing an optical component using a polymeric composition containing an aversive additive, according to an exemplary embodiment;

FIG. 3 depicts an optical fiber cable having a multilayer jacket containing different aversive additives in each layer, according to an exemplary embodiment; and

FIGS. 4-7 depict other examples of optical containers that can be formed from the polymeric composition having the mechanical and chemical aversive additives, according to exemplary embodiments.

### DETAILED DESCRIPTION

Referring generally to the figures, various embodiments of a polymer composition containing a mechanical and chemical aversive for repelling animals from optical containers made from or including the polymer composition are provided. In particular, the polymer composition is suitable for use in optical containers of optical components, such as cable jackets of optical fiber cables or optical fiber splice enclosures. Advantageously, the combination of mechanical and chemical aversive provides a wide range of protection against animal attack for any of the various reasons that animals, especially rodents, chew or gnaw on the optical containers. As will be discussed more fully below, the mechanical and chemical aversive can be combined in a single additive in the form of an open inorganic particle infused with a chemical aversive material. The polymer composition can further include additional inorganic particles to enhance the mechanical aversive effect. The mechanical and chemical aversive can be compounded into the polymeric composition at high temperatures, and the structures formed from the polymeric composition are resistant to environmental degradation. Further, the aversive additive is dispersed evenly throughout the polymer, and the chemical aversive is released upon interaction with an animal. These and other embodiments will be described herein and in relation to the figures. Such exemplary embodiments are provided by way of illustration and not by way of limitation.

As disclosed herein, the polymeric composition containing the aversive additive can be incorporated into a variety of different optical containers of optical components. In the present disclosure, an “optical container” is a structure configured to house one or more optical elements. The optical container is formed at least in part from the polymeric composition containing the aversive additive, including by extruding, molding, overmolding, and injection molding of the structure of the optical container. In one or more embodiments, the optical container may be a cable jacket, an enclosure (e.g., a splice joint enclosure, cabinet, enclosure box, dome enclosure, etc.), an overmold structure (e.g., FlexNAP™ system closure), or single-or multi-port terminals, among other possibilities. Further, as used herein, an “optical component” is the combination of the optical container and at least one optical element, which may be one or more optical fibers or may be a structure that contains one or more optical fibers as will be discussed below.

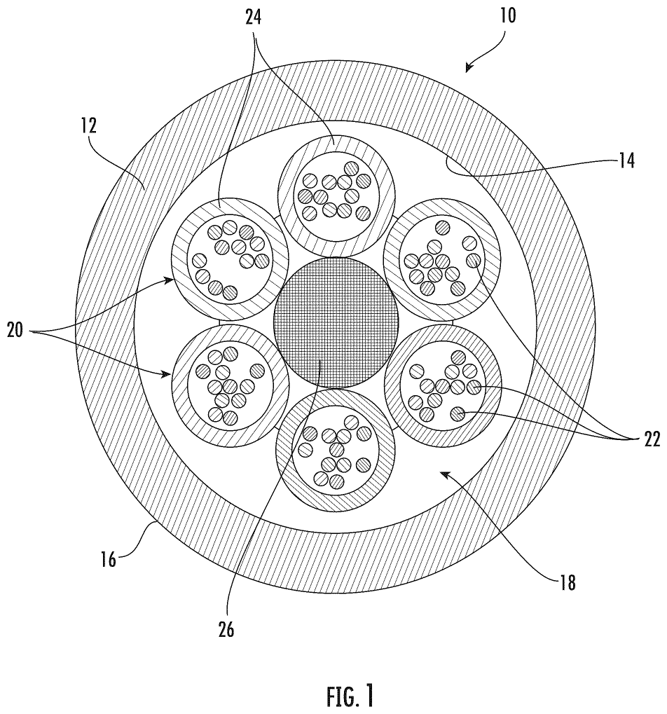

FIG. 1 depicts an exemplary embodiment of an optical component in the form of an optical fiber cable 10 having an optical container in the form of a cable jacket 12. The cable jacket 12 has an inner surface 14 and an outer surface 16. The inner surface 14 of the cable jacket 12 defines a central bore 18 that extends along the length of the optical fiber cable 10. The outer surface 16 defines an outermost surface of the optical fiber cable 10. Disposed within the central bore 18 are one or more optical elements 20. As used herein, an “optical element” is an optical fiber 22 or is a structure containing at least one optical fiber 22. Thus, the optical elements 20 can be, for example, a single optical fiber 22, multiple optical fibers 22 (including optical fibers 22 in a bundled configuration, stranded configuration, rigid or rollable ribbon configuration, tight buffered configuration, or loose tube configuration within the cable jacket 12), one or more optical fibers 22 contained in one or more buffer tubes 24 (including optical fibers 22 in a bundled configuration, stranded configuration, rigid or rollable ribbon configuration, tight buffered configuration, or loose tube configuration within the one or more buffer tubes 24), or a plurality of optical fibers 22 or ribbons of optical fibers 22 contained in thin polymeric membranes. In the embodiment depicted in FIG. 1, the optical elements 20 are buffer tubes 24 containing a plurality of optical fibers 22 in a loose tube configuration.

Further, in the embodiment depicted in FIG. 1, the buffer tubes 24 are stranded around a central strength member 26, which may be a glass-reinforced plastic rod upjacketed with a layer of polymeric material. The optical fiber cable 10 may contain other structures, such as layers of water blocking tape, binder wraps or films, and strengthening yarns, among other possibilities. In one or more embodiments, the optical fiber cable 10 does not include a metal armor component, such as a metal tape layer or a layer of metal wires. Such armor layers add to the weight and cost of the optical fiber cable, and the metal of the armor layer is subject to corrosion and must be grounded, which introduces additional design challenges. Thus, in one or more embodiments, avoiding the use of metal armor layers in the optical fiber cable 10 is desirable.

With respect to the optical fiber cable 10 of FIG. 1, the polymeric composition containing the aversive additive may be contained in the cable jacket 12 to prevent rodents or other animals from interacting with the optical fiber cable 10. The polymeric composition includes a polymeric component into which the aversive additive in the form of infused particles and, optionally, inorganic particles are dispersed. The infused particles are open inorganic particles into which an aversive additive is infused. The infused particles act as both a mechanical aversive and as a chemical aversive. That is, the inorganic structure of the infused particles provides an unpleasant physical stimulus (e.g., hardness or irritation) to an animal biting or gnawing on the cable jacket 12, and the chemical aversive material of the infused particles provides an unpleasant chemical stimulus (e.g., taste, smell, or burning sensation) to the animal. Further, by infusing the chemical aversive material into the inorganic structure, the chemical aversive material does not leach from the cable jacket 12 and is released when the animal applies bite pressure to the cable jacket 12.

The aversive additive can be compounded with a variety of suitable polymers, including thermoplastic polymers, thermoset polymers, elastomers, and thermoplastic elastomers. Exemplary polymers include ethylene-vinyl acetate copolymers, ethylene-acrylate copolymers, polyethylene homopolymers (low, medium, and high density), linear low density polyethylene, very low density polyethylene, polypropylene homopolymer, polyolefin elastomer copolymer, polyethylene-polypropylene copolymer, butene- and octane-branched copolymers, or maleic anhydride-grafted versions of the polymers listed above. In one or more other embodiments, the polymer composition may include halogenated thermoplastics (such as polyvinyl chloride), thermoplastic polyurethane, or a crosslinked polyethylene.

In still one or more other embodiments, the polymeric composition may be compounded with one or more engineering plastics, such as polyethylene terephthalate, polybutylene terephthalate, polyether ether ketone, acrylonitrile butadiene styrene, polyamides (in particular nylon 6,6 or nylon 6,12), polysulfone, polycarbonate, polyphthalamide, poly(methyl methacrylate), styrene-acrylonitrile, polytetrafluoroethylene, polyvinylidene fluoride, acetal (polyoxymethylene), polyethylenimine, polyphenylene sulfide, poly(p-phenylene oxide), amorphous polyetherimide, ultra high molecular weight polyethylene, ionomers (such as Surlyn®), or polyamide-imide. The engineering plastics may provide additional toughness to the cable jacket 12 to dissuade an animal from gnawing or chewing on the cable jacket 12. In one or more embodiments, the engineering plastic is selected to have a hardness of at least 87 on the Rockwell R scale as measured according to ASTM D785, especially when the optical container is a splice enclosure (providing compliance with GR-771-CORE). In one or more embodiments, the engineering plastic is selected to have an Izod impact strength of at least 0.25 J/cm as measured according to ASTM D256 Type A.

The polymeric composition includes as the infused particles any of a variety of open inorganic particles into which a chemical aversive material is infused. By “open,” it is meant that the structure of the inorganic particles is capable of holding the chemical aversive material within its structure. For example, the inorganic particles may be porous or tubular. In one or more embodiments, the inorganic particle is one or more of zeolite, cordierite, halloysite nanotubes, aluminum-titanate composites, magnesium silicate composites, cucryptite, and other silicates, oxides, or hydroxides. In one or more embodiments, the open inorganic particles are within a size range of 20 to 400 mesh, in particular from 50 to 120 mesh. That is, the open inorganic particles will pass through a mesh of size 20 but not pass through a mesh of size 400, or more particularly, the open inorganic particles will pass through a mesh of size 50 but not pass through a mesh of size 120.

As used herein, a “chemical aversive material” is one that will repel an animal in the particular environment in which the chemical aversive material is used. Generally, the chemical aversive material will trigger a flavor, olfactory, or tactile response in the animal, repelling the animal from, e.g., chewing, pecking, or climbing on the structure containing the aversive material. In one or more embodiments, the chemical aversive material is cinnamaldehyde, wintergreen oil, capsaicin, peppermint oil, bergamot oil, geranium oil, natural or synthetic urine (especially predator urine), eucalyptus, bitterants, pinene, lemon citrus oil, cedarwood oil, garlic oil, lithium chloride, natural or synthetic pepper derivatives, tannin, denatonium benzoate (e.g., Bitrex®), bitumen, catnip, nookatone, perilla leaves (all components, any combination of components, or a single component), vanillas (all components, any combination of components, or a single component), and any other aversive materials known in the art to produce an aversive reaction to an animal or animals in any or all environments.

As mentioned above, the polymeric composition may additionally contain inorganic particles that are not infused with a chemical aversive material. Such inorganic particles may be open inorganic particles, such as those mentioned above, including zeolite, cordierite, halloysite nanotubes, aluminum-titanate composites, magnesium silicate composites, and cucryptite. Additionally, the inorganic particles may be aluminum oxide, silicon dioxide, silicon carbide, carborundum, ruby, sapphire, diamond, garnet, amethyst, quartz, feldspar, topaz, granite, emery, marble, optical glass, or glass spheres. In one or more embodiments, the inorganic particles are within a size range of 20 to 400 mesh, in particular from 50 to 120 mesh.

In one or more embodiments, the inorganic particles, including both the infused and non-infused inorganic particles, have a Mohs hardness of 5 or higher. Such a hardness is as hard or harder than rodent teeth, meaning that biting into such inorganic particles will produce an undesirable tactile feedback for the rodent.

In the polymeric composition, the polymeric composition includes 0.2 to 12% by weight, in particular 0.4% to 4% by weight, of the infused particles. When included, the polymeric composition includes 2% to 40% by weight, in particular 5% to 15% by weight, of the inorganic particles. In an embodiment, the infused particles and optional other inorganic particles are mixed with other optional polymer additives prior to or during compounding of the polymer composition. Typical polymer additives include pigments, stabilizers, fungicides, and fillers (in addition to the inorganic particles). In certain embodiments, the infused particles and any optional inorganic particles and other additives together comprise from 2% to 50% by weight of the polymer composition.

Having described the polymer composition, a method of infusing open inorganic particles with chemical aversive material is now described. In one or more embodiments, a solution of the chemical aversive material and a solvent is prepared. In one or more embodiments, the solution may contain 10:90 to 50:50 ratio of solvent to chemical aversive material. In embodiments, the solvent is used to lower the viscosity of the chemical aversive material so that the solution containing the chemical aversive material can infuse into the pores or tubes of the open inorganic material. A variety of solvents may be used to form the aversive solution so long as the chemical aversive material is soluble in the solvent. Thereafter, in embodiments, the porous inorganic material is infused with the aversive solution. In embodiments, the ratio of open inorganic material to aversive solution is from 1:2 to 1:20. In embodiments, the mixture of open inorganic particles and aversive solution is sonicated and placed under vacuum (e.g., 10 inHg to 29.5 inHg) to assist infusion. The mixture may remain under vacuum for a time of 20 minutes to 120 minutes, and the vacuum is slowly released to atmospheric pressure over a time period of, e.g., 30 minutes to 4 hours. In embodiments, the concentration of chemical aversive material in the open inorganic material is from 60 ng/ml to 10 mg/ml.

In an experimental embodiment, samples of zeolite Y were infused with a solution of chemical aversive material at 1 part zeolite to 10 parts aversive solution. In a first example embodiment, the zeolite material was infused with peppermint oil, and in another example embodiment, the zeolite material was infused with menthol. The samples were sonicated in the solution and placed in a vacuum desiccator for a time period of over 20 minutes. Vacuum was pulled at 24 inHg. The vacuum was released slowly over 30 minutes to allow infusion of the aversive solution into the pores of the porous inorganic material. The samples were then centrifuged, the solution was decanted, and the material was rinsed and centrifuged with ethanol, followed by 50:50 ethanol:water, and finally water. In other embodiments, the number of washing steps may be reduced to speed up the infusion process. The samples were then dried by lyophilization.

Advantageously, the open inorganic particles protect the chemical aversive material during compounding and forming despite exposure to temperatures of greater than 150° C., which might otherwise cause degradation of an unprotected chemical aversive material. In this way, the aversive additive as described herein can be extruded or molded with or otherwise dispersed in a polymer usable in a variety of applications. In some embodiments, the aversive additive described herein is added to a thermoplastic polymer material that is then melted and shaped through extrusion, overmolding, injection molding, compression molding, or any other suitable process to form a polymeric article. In other embodiments, the aversive additive described herein is added to a polymer precursor mixture that is then cured or cross-linked, e.g., via UV, heating, etc., to form a polymeric article.

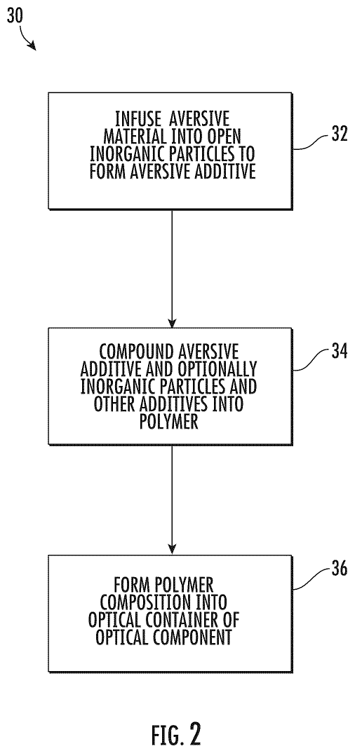

Based on the foregoing, the present disclosure also relates to a method of preparing an optical component, such as the optical cable 10 of FIG. 1. FIG. 2 depicts a flow diagram of the method 30. In the method 30, the aversive additive is prepared by infusing the chemical aversive material into the open inorganic particles in a first step 32. As discussed above, the aversive additive is prepared by forming a solution of the chemical aversive material and a solvent, and the solution is then mixed with the open inorganic particles and held under vacuum for a time sufficient to infuse the solution into the open inorganic particles. In a second step 34, the aversive additive and any optional additional inorganic particles and other additives are compounded with a polymer. Because the chemical aversive material (which is typically an organic compound) is protected by the open inorganic particles, the aversive additive can be compounded with a polymer at temperatures of 150° C. or higher to form the polymer composition. In a third step 36, the polymer composition is formed into an optical container of an optical component. For example, the polymer composition may be extruded, overmolded, injection molded, or compression molded, among other forming techniques.

Returning to the embodiment of an optical fiber cable 10, such as the optical fiber cable shown in FIG. 1, an example embodiment is now discussed. In the example embodiment, the optical fiber cable 10 has a cable jacket 12 comprised of the polymeric composition in which the polymeric component is nylon, in particular nylon 6,6 or nylon 6,12. The use of nylon provides a toughness to the cable jacket 12 that provides some deterrent effect to the optical fiber cable 10. That is, using a tougher material for the cable jacket 12 means that the rodent must expend more energy to chew through or cut away the polymeric material of the cable jacket 12. In the polymeric composition of the cable jacket 12, the infused particles are zeolite containing the chemical aversive material, in particular zeolite Y infused with peppermint oil or menthol. Further, the polymeric composition of the cable jacket 12 includes a further inorganic particle is included in the form of aluminum oxide particles. As discussed above, the infused particles and the other inorganic particles have a size that is 20 to 400 mesh, in particular 50 to 120 mesh. Further, infused particles are provided in an amount of 0.2% to 12% by weight, in particular 0.4% to 4% by weight, of the polymeric composition. The inorganic particles are provided in an amount of 2% to 40% by weight, in particular 5% to 15% by weight. A cable according to the foregoing construction is expected to provide enhanced resistance to rodent attack using both the mechanical and chemical aversive contained in the polymeric composition of the cable jacket 12.

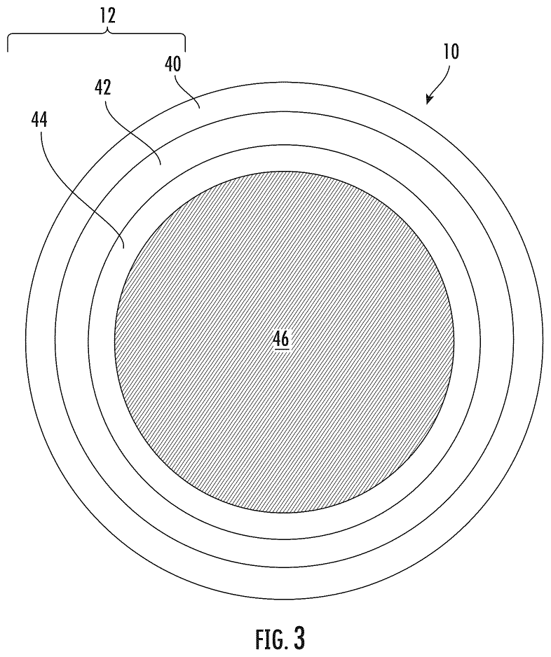

FIG. 3 depicts another embodiment of an optical fiber cable 10 in which the mechanical and chemical aversive is provided in different layers. In FIG. 3, the optical fiber cable 10 has a multilayer cable jacket 12. In one or more embodiments, the first layer 40 may contain inorganic particles dispersed in a polymer matrix. In one or more embodiments, the second layer 42 may be comprised of a tough polymer or engineering plastic, such as nylon 6,6 or nylon 6,12. In one or more embodiments, the third layer 44 may be comprised of infused particles dispersed in a polymer matrix. The order of the layers 40, 42, 44 is not mandatory, and in one or more other embodiments, the layers comprising the inorganic particles, the tough polymer, and the infused particles may be arranged in a different order. In FIG. 3, the cable jacket 12 is depicted as surrounding a cable core 46, which is a schematic representation of the internal structure of the optical fiber cable 10. The cable core 46 includes at least the optical element 20 (e.g., the optical fibers 22 and buffer tubes 24, such as shown in FIG. 1) as well as other structures, such as a central strength member 26 (e.g., as shown in FIG. 1), water blocking tape, binder wraps or films, and/or strengthening yarns.

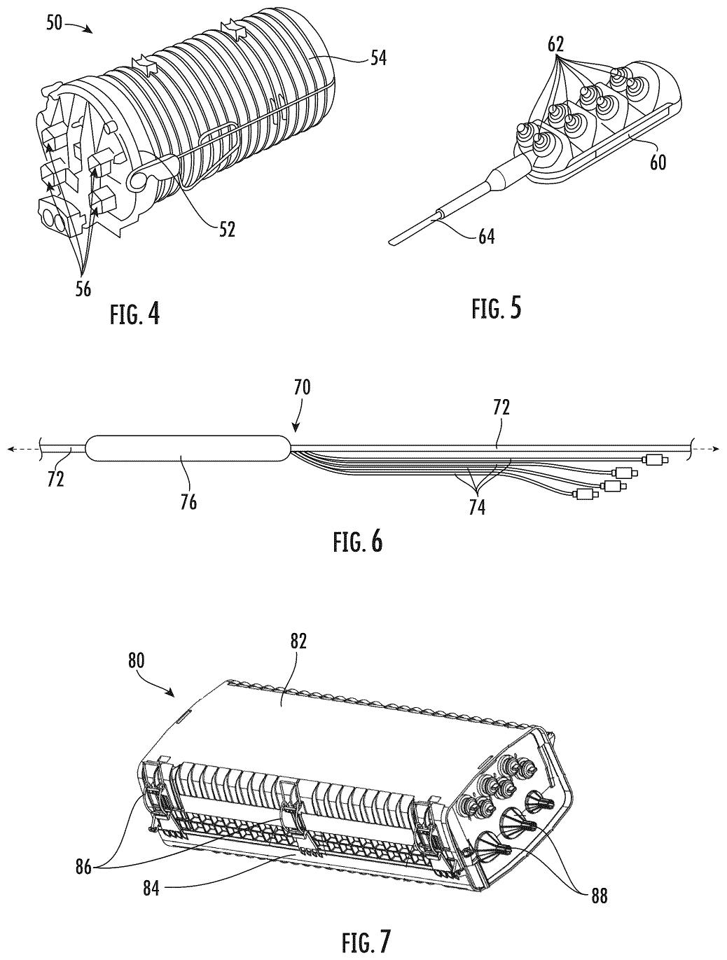

The embodiments of the polymer composition incorporated into the optical fiber cable 10 are provided for the purposes of illustration only and not by way of limitation. Indeed, the polymeric composition can be incorporated in many other optical components using the polymer composition as the optical container or as part of the optical container. For example, FIGS. 4-7 depict examples of other optical components that can be formed, at least in part, from the polymer composition.

FIG. 4 depicts an embodiment of an enclosure 50. The enclosure 50 has a base 52 and a dome 54. The base 52 has a plurality of ports 56 into which optical fiber cables enter or from which optical fiber cables exit. Within the dome 54, optical fibers from the cables are joined to make connections within an optical network. The base 52 and the dome 54 are joined to form the enclosure 50, which protects these connections from the environment. In one or more embodiments, either or both of the base 52 and the dome 54 may be formed from the polymeric composition containing the aversive additive.

FIG. 5 depicts an embodiment of a terminal 60. Such terminals may have one or multiple ports 62. An optical fiber cable 64 leads into the terminal 60, and one or more optical fibers of the optical fiber cable 64 terminates at each port 62. Connectorized optical fiber cables can be plugged into the ports 62 to provide optical connections between the optical fibers of the optical fiber cable 64 entering the terminal 60 and connectorized optical fiber cables exiting from the terminal 60. In one or more embodiments, the body of the terminal 60 is formed from the polymeric composition containing the aversive additive.

FIG. 6 depicts an embodiment of a furcated optical fiber cable 70. The furcated optical fiber cable 70 has a main cable body 72 from which multiple tether cables 74 are divided. In order to furcate the tether cables 74 from the main cable body 72, the jacket of the main cable body 72 is breached so that the optical fibers carried therein can be spliced to the optical fibers of the tether cables 74. At the location where the tether cables 74 are furcated from main cable body 72, an overmold 76 is provided around the main body cable 72 and the start of the tether cables 74 to protect main cable body 72 from intrusion by water or other environmental agents. In one or more embodiments, the overmold 76 may be formed from the polymeric composition containing the aversive additive.

FIG. 7 depicts an embodiment of another enclosure 80. As opposed to the dome enclosure of FIG. 4, the enclosure 80 of FIG. 8 is a generally rectangular box-style enclosure. The enclosure 80 has a top 82 and a bottom 84. The top 82 and bottom 84 may be connected with a hinge joint and closed with a plurality of clasps 86. Each end of the enclosure 80 may include a plurality of ports 88 into which or out of which an optical fiber cable may extend. Within the enclosure 80, optical fibers are spliced or joined, and the enclosure 80 protects the splice or joint from the surrounding environment. In one or more embodiments, the enclosure 80, including the top 82 and the bottom 84, may be formed from the polymeric composition containing the aversive additive.

While FIGS. 4-7 depict various examples of optical components formed, at least in part, from the polymeric composition containing the aversive additive, these examples should be considered merely illustrative, and not limiting. Other optical components having an optical container surrounding or configured to surround at least one optical element may also be formed from the disclosed polymeric composition.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical component, comprising:
an optical container comprising a polymeric composition;
an optical element comprising at least one optical fiber, the optical element being disposed within the optical container;
wherein the polymeric composition comprises:
a polymer component; and
a first aversive additive dispersed in the polymer component, the first aversive additive comprising:
first inorganic particles, the first inorganic particles having an open structure; and
a chemical aversive material infused into the first inorganic particles.

2. The optical component of claim 1, wherein the first inorganic particles comprise at least one of zeolite, cordierite, halloysite, aluminum-titanate composites, magnesium silicate composites, or eucryptite.

3. The optical component of claim 1, wherein the first inorganic particles comprise a size of 20 to 400 mesh.

4. The optical component of claim 1, wherein the polymeric composition comprises from 0.2% to 12% by weight of the first aversive additive.

5. The optical component of claim 1, further comprising a second aversive additive, the second aversive additive comprising second inorganic particles, wherein the second inorganic particles are not infused with a chemical aversive material.

6. The optical component of claim 5, wherein the second inorganic particles comprise zeolite, cordierite, halloysite nanotubes, aluminum-titanate composites, magnesium silicate composites, eucryptite, aluminum oxide, silicon dioxide, silicon carbide, carborundum, ruby, sapphire, diamond, garnet, amethyst, quartz, feldspar, topaz, granite, emery, marble, optical glass, or glass spheres.

7. The optical component of claim 5, wherein the polymeric composition comprises from 2% to 40% by weight of the second aversive additive.

8. The optical component of claim 5, wherein the first inorganic particles and the second inorganic particles have a Mohs hardness of 5 or higher.

9. The optical component of claim 1, wherein the optical component is an optical fiber cable and the optical container is a cable jacket.

10. The optical component of claim 9, wherein the cable jacket comprises a first layer, a second layer, and a third layer;
wherein the first layer comprises the polymeric composition;
wherein the second layer comprises a second aversive additive dispersed in a second polymer component, the second aversive additive comprising second inorganic particles that are not infused with a chemical aversive material; and
wherein the third layer comprises a third polymer component that does not include the first aversive additive or the second aversive additive.

11. The optical component of claim 10, wherein the third polymer component comprises an engineering plastic having an Izod impact strength of at least 0.25 J/cm as measured according to ASTM D256 Type A.

12. The optical component of claim 10, wherein the third polymer component comprises nylon 6,6 or nylon 6,12.

13. The optical component of claim 9, wherein the optical fiber cable does not comprise a metal armor component.

14. The optical component of claim 1, wherein the chemical aversive material comprises cinnamaldehyde, wintergreen oil, capsaicin, peppermint oil, bergamot oil, geranium oil, natural or synthetic urine, eucalyptus, bitterants, pinene, lemon citrus oil, cedarwood oil, garlic oil, lithium chloride, natural or synthetic pepper derivatives, tannin, denatonium benzoate, bitumen, catnip, nookatone, at least one component of perilla leaves, or at least one component of vanilla.

15. The optical component of claim 1, wherein the optical component is a junction box, a dome enclosure, a single-or multi-port terminal, or an overmold of a cable division.

16. A method of forming an optical component, comprising:
infusing a chemical aversive material into first inorganic particles having an open structure to form a first aversive additive;
compounding the first aversive additive with a polymer component to form a polymeric composition; and
forming the polymer composition into an optical container of the optical component, the optical container configured to surround at least one optical element of the optical component.

17. The method of claim 16, wherein the polymeric composition comprises from 0.2% to 12% by weight of the first aversive additive.

18. The method of claim 16, wherein the first inorganic particles comprise a size of 20 to 400 mesh.

19. The method of claim 16, wherein compounding further comprises compounding the first aversive additive and a second aversive additive with the polymer component, the second aversive additive comprising second inorganic particles, wherein the second inorganic particles are not infused with a chemical aversive material.

20. The method of claim 19, wherein the second inorganic particles comprise zeolite, cordierite, halloysite nanotubes, aluminum-titanate composites, magnesium silicate composites, eucryptite, aluminum oxide, silicon dioxide, silicon carbide, carborundum, ruby, sapphire, diamond, garnet, amethyst, quartz, feldspar, topaz, granite, emery, marble, optical glass, or glass spheres.

21. The method of claim 19, wherein the polymeric composition comprises from 2% to 40% by weight of the second aversive additive.

22. The method of claim 19, wherein the first inorganic particles and the second inorganic particles have a Mohs hardness of 5 or higher.
